(19) United States
(12) Patent Application Publication
(10) Pub. No.: US 2013/0304633 A1
(43) Pub. Date: Nov. 14, 2013

(54) INTERACTIVE SYSTEM

(71) Applicant: TAILORBET LIMITED, Onchan (GB)

(72) Inventors: David McKenzie, Onchan (GB); Kevin Yu-Chang Lo, Onchan (GB); David Kim Silva, Onchan (GB); Christian Atichian, Sydney (AU)

(73) Assignee: TAILORBET LIMITED, Onchan (GB)

(21) Appl. No.: 13/771,725

(22) Filed: Feb. 20, 2013

Related U.S. Application Data
(63) Continuation of application No. PCT/AU2012/001275, filed on Oct. 12, 2012.

(30) Foreign Application Priority Data
May 14, 2012 (GB) 1208392.9

(51) Int. Cl. G06Q 20/22

(52) U.S. Cl. CPC G06Q 20/29
USPC 705/39

(57) ABSTRACT

An interactive system for creating, offering and processing a series of partial transactions between one or more nodes in substantially real time to establish a complete transaction between two nodes is disclosed. The system may include a delivery node for offering partial transactions, a central node configured to receive and collate partial transactions from the delivery node and to provide information regarding partial transactions simultaneously to one or more user nodes configured to receive and review partial transactions from the central node, and a parsing module is provided which is configured to amend pre-selected details pertaining to the or each partial transaction delivered to it by the delivery node to generate at least one parsed partial transaction.

### CROSS REFERENCE TO RELATED APPLICATIONS

This patent application is a continuation of PCT/AU2012/001275 filed Oct. 12, 2012, and claims priority under 35 U.S.C. §119(a)-(d) to Great Britain Patent Application No. 1208392.9, filed May 14, 2012. Each of the above-identified patent applications is incorporated herein by reference in its entirety.

### FIELD OF THE INVENTION

The present invention relates to an interactive system for matching partial transactions and more specifically relates to matching partial transactions across varied platforms to create complete transactions.

### BACKGROUND

Previous systems have been proposed and used which employ a variety of techniques and technologies to offer potential transactions to other, remote users, to be converted into completed transactions, but problems are faced by users working with transactions under these systems.

Particularly, current systems which offer a partial transaction to a user lack customisability and are, as systems, substantially closed. Therefore, the present invention proposes a more open system which may provide and complete partial transactions.

### SUMMARY OF THE INVENTION

Accordingly, the present invention provides an interactive system for creating, offering and processing a series of partial transactions between one or more nodes in substantially real time to establish a complete transaction between two nodes, the system comprising a delivery node for offering partial transactions, a central node configured to receive and collate partial transactions from the delivery node and to provide information regarding partial transactions simultaneously to one or more user nodes configured to receive and review partial transactions from the central node; wherein a parsing module is provided which is configured to amend pre-selected details pertaining to the or each partial transaction delivered to it by the delivery node to generate at least one parsed partial transaction, the central node provides the or each parsed partial transaction to the or each user node, and the central node is configured to receive at least one reviewed parsed partial transaction from the or each user node and to convert the or each reviewed parsed partial transaction into a complete transaction, and to subsequently provide information regarding the or each completed transaction to the delivery node.

Preferably, the delivery node constructs the partial transactions based on criteria entered at the delivery node.

Conveniently, the parsing module parses the transactions dependent upon the intended recipient user node.

Advantageously, the parsing module is a part of the central node.

Preferably, the parsing module is configured to parse a partial transaction and present the same parsed partial transaction in a different form to two different user nodes.

Alternatively, the parsing module is configured to parse a partial transaction and present the partial transaction to a particular user node dependent upon the content of the partial transaction.

Conveniently, the central node is configured to provide the same parsed partial transaction to two differing user nodes but present the same transaction in a different form, the transaction conveying the same technical information to each user node with the transaction being expressed at each user node differently.

Advantageously, different central nodes are operable to offer only a predetermined selection of parsed partial transactions, which are different, to the same user node, or wherein different central nodes are operable to offer only a predetermined selection of parsed partial transactions, which are not different, to the same user node.

Preferably, a matching engine to match partial transactions is provided to assist pairing a user node with a partial transaction offered on a central node.

Conveniently, the matching engine is a part of the central node.

Advantageously, a partial transaction comprises an offered wager composed of bet terms, bet options and a wager or odds.

Preferably, an availability engine dictates partial transaction availability to the central node with reference to the identity of a user node, with only the predetermined selected offered transactions and completed transactions for that user node being accessible by that particular user node.

Conveniently, the user node comprises a sportsbook service provider system.

Alternatively, the user node comprises a user-facing client terminal.

Advantageously, a partial transaction is constructed between the delivery node and the central node and provided to a verification engine for verification and then, if verified, is offered to the or each user node.

Preferably, the system further comprises a selection engine to determine if a partial transaction from the central node is eligible for offer to a user node depending on selection criteria including at least the nature of the transaction and the identity of the user node so that the or each user node has access to offer a predetermined selection of partial transactions from the central node.

Conveniently, the selection engine is part of the central node.

Advantageously, the selection engine determines the pre-selected details to be amended by the parsing module.

### BRIEF DESCRIPTION OF THE DRAWINGS

The present invention will now be described with reference to the accompanying figures, in which:

FIG. 1 shows a schematic diagram of an interactive system which embodies the present invention;

FIG. 2 shows an example of a user interface which forms part of the present invention;

FIG. 3 shows an example of a sportsbook interface which forms part of the present invention; and

FIG. 4 shows an example of a further user interface which also forms part of the present invention.

### DETAILED DESCRIPTION

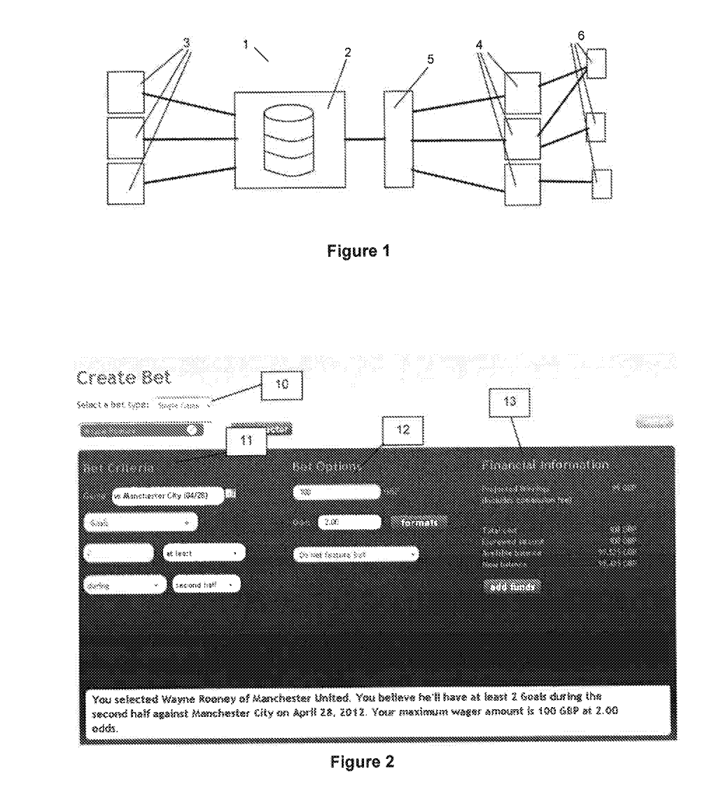

Turning firstly to FIG. 1, a schematic diagram of an interactive system 1 according to the present invention is shown. The system includes a central node 2, a delivery node or nodes 3, a, a client node or nodes 4, and a parsing module 5. As can be seen, the central node 2, the delivery node or nodes 3, the client node or nodes 4 and the parsing module 5 may all be connected, the connections between the nodes 2, 3, 4 and module 5 may be one directional or bi-directional—the connections between these nodes 2, 3, 4 and module 5 will be discussed in more detail later.

The central node 2 may form the hub of the system 1, and may be a web server or similar, or in some embodiments, may be a cluster or farm of servers, dependent upon the intended application of the system 1. The central node 2 may accept incoming and outgoing data, and may further include processing arrangements, such as data analysis engines, data compression engines, calculation modules or the like. The central node may further include additional features or arrangements, dependent upon the intended use of the system 1.

The central node 2 may be remote from the delivery node or nodes 3, the client node or nodes 4 and the parsing module 5, but it is to be understood that in some embodiments, all portions of the system 1 may be co-located, or indeed only some portions of the system 1 may be co-located. The nodes 2, 3, 4 and the module 5 do not need to be co-located—in some embodiments, it is particularly suitable if some or all of the nodes 2, 3, 4 and the module 5 are not co-located, but connected by way of high-speed network connections.

Further, the central node 2 may include the parsing module 5, or, as shown in FIG. 1, the parsing module 5 may be separate from the central node 2, with the central node 2 and the parsing module 5 in bi-directional communication. The parsing module 5 will be discussed in more detail later.

The delivery node or nodes 3 may be connected to the central node 2 to allow bi-directional communication, or, may be connected such that the delivery node or nodes 3 are in one-way communication with, and are able to transmit data to, the central node 2. However, in most embodiments of the system 1, the delivery node or nodes 3 are configured to be in bi-directional communication with the central node 2, to enable data to be retrieved from the central node 2 for preparation of partial transactions, as discussed later.

The delivery node or nodes 3 may be configured to accept input from a user, and may present the user with a user interface to allow data to be inputted, which may be a web client or similar, configured to communicate with the central node 2, and to present a user with a form or the like. Data inputted into the form may be transmitted to the central node 2, for storage or processing, and a copy of the inputted data may be stored locally on the delivery node 3.

The data which have been inputted into the form may be converted to a different format prior to transmission to the central node 2, for instance into an XML file or the like, or may be encoded into a proprietary format. The copy of the data which may be stored locally on the delivery node 3 may be in an archive or backup format.

The inputted data may then be used to generate a partial transaction on the delivery node or node 2, and may then be transmitted to the central node 3. A partial transaction may be an offer of a sale, bet or wager, and may be an incomplete transaction, insofar as that the transaction has not been completed by a complementary payment or offer of payment. A partial transaction may take any suitable format, and may, for instance, be encoded in XML format, or may take any suitable data format capable of transmission to and decoding by the central node 2.

A partial transaction may give rise to more than one completed transaction, because more than one payment or offer of payment could be made against one partial transaction. This will be discussed in more detail later.

The user interface may be configured to present a user present at the delivery node 2 with data or options that may be selected, when creating a partial transaction and in particular a partial transaction which is a bet or wager. The options presented to the user may include, but are not limited to:
Selecting whether the bet or wager relates to a single game, a game that is presently in-play, or whether the bet or wager relates to an extended period, for instance relating to a number of games or occurrences during a set period;
Entering statistical criteria, a bet or wager amount and other associated options, which may include odds, duration, or the like, and financial information, which may include bank or payment details of the user;
Reviewing the information provided;
Submitting the bet or wager for transmission as a partial transaction from the user node 3 to the central node 2; and
Selecting whether the bet is a ‘private bet’ (not to be submitted to a sportsbook) or a standard bet to be submitted to a sportsbook (private bets will be discussed in more detail later).

An example of the options presented to a user at a user node 3 is shown in FIG. 2. As can be seen in FIG. 2, a user is presented with a selection of options, which may include a bet type selection 10, a bet criteria selection 11, a bet options selection 12 and financial information readout 13. The selections 10, 11 and 12 may all be configured to present a number of options to the user, and the user may also be able to add options to the selections 10, 11 and 12 to suit the partial transaction that they are seeking to create—in some embodiments, the selections 10, 11, 12 may be pre-determined, to allow only a particular range of partial transactions to be prepared. However, in other embodiments, to enable a wider range of partial transactions to be prepared, the selections 10, 11, 12 may be user-driven. The financial information 13 may include information regarding a user's present balance, the amount they are willing to wager, or any other suitable information.

The data forming the partial transaction may be formed of the selections 10, 11, 12—the options selected, when combined, result in a particular partial transaction.

Further, when the partial transaction is created, the user node 3 may attach further information to the partial transaction, which may include the IP address of the user node 3, the details of a user logged in to the user node 3, bank details of a user logged into the user node 3, the time and date of creation of the partial transaction, or any other relevant information. It is to be understood that, dependent upon the nature of the partial transaction, any suitable data may be attached to the partial transaction.

The user node or nodes 4 may, in a similar fashion to the delivery node or nodes 3, be connected to the central node 2 to allow bi-directional communication, or, may be connected such that the user node or nodes 4 are in one-way communication with, and are able to receive data from, the central node 2.

The parsing module 5, as discussed above, may lie between the central node 2 and the user node or nodes 4, and may be part of the central node 2, or may be a separate module. In either circumstance, the parsing module 5 may be configured to parse partial transaction data transmitted from the central node 2 to the user node or nodes 4, to create parsed partial transactions. The parsing is configured dependent upon the intended use of the system 1.

Particularly, the parsing module 5 may be configured to remove or hide data attached to partial transactions generated by the delivery node or nodes 3, for instance user details or bank details, prior to the partial transaction or transactions being transmitted to the user node or nodes 4. The data, if hidden or removed, may be stored in a separate location, for instance in a database on the central node 2, so that the information may be re-attached to the partial transactions if required, or if the data is required for audit purposes or the like. The parsing module 5 may be configured to re-attach or re-enable the information removed or hidden from a partial transaction.

The parsing module 5 may also, when parsing partial transactions, identify partial transactions which are standard bets to be transmitted to a sportsbook, and those which are private bets—these two classifications of partial transaction may dictate the way in and destination to which they are to be transmitted. Private bets may be marked as not for transmission to a sportsbook, or alternatively, may be marked for transmission to a particular user node 4 or selection of user nodes 4.

Of course, the parsing module 5 may be configured to undertake any suitable parsing operation on the data relating to a partial transaction or transactions, dependent upon the nature of the partial transaction and the intended recipient of the partial transaction.

Further, the parsing module 5 may also remove or hide data attached to completed transactions which are transmitted from the user node or nodes 4 to the central node 2, or indeed, may be used to remove data attached to information transmitted from the delivery node or nodes 3 to the central node 2, dependent upon the intended use of the system.

The user nodes may be configured to receive data from the central node 2, with the data transmitted from the central node 2 being parsed by the parsing module 5 as discussed above. The parsing module 5 may add or remove details from the partial transaction data transmitted from the central node 2 to the user node or nodes 4, or may indeed work in the reverse direction, removing or adding data from completed transactions transmitted from the user node or nodes 4 to the central node 2.

The user node or nodes 4 may be a sportsbook or similar, and may be a web server or web servers, configured to communicate with the central node 2. Parsed partial transactions are transmitted to the user node or nodes 4, and may take any suitable format for data transmission, including XML or a similar encoded format, or any other suitable data format. The parsed partial transactions may be streamed to the user node or nodes 4, or may be transmitted on a transaction-by-transaction basis, dependent upon the sought application of the system 1.

Alternatively, in the case of a private bet, the user node 4 may be a user connected directly to the central node, with the transaction made available only to that particular user node 4, or to a particular selection of user nodes 4. In other embodiments, the partial transactions which are identified as being private bets may be transmitted directly to a client or clients 6, bypassing the user node or nodes 4.

The user node or nodes 4 may be configured to decode the individual or streamed parsed partial transactions, and may store a copy of the transactions locally on the user node or nodes 4. The user node or nodes 4 may then provide a web-page or similar, giving details of some or all of the parsed partial transactions available at any one time. Different sportsbooks may have access to different parsed partial transactions, and as a result, the central node 2 and parsing module 5 may make different parsed partial transactions available to different user nodes 4.

When determining which user nodes 4 have access to particular parsed partial transactions, factors such as the identity of the sportsbook, the nationality of the sportsbook and the type of wagers offered by the sportsbook may be taken into consideration, along with any other factors which may be relevant—such factors will be understood by persons skilled in the art.

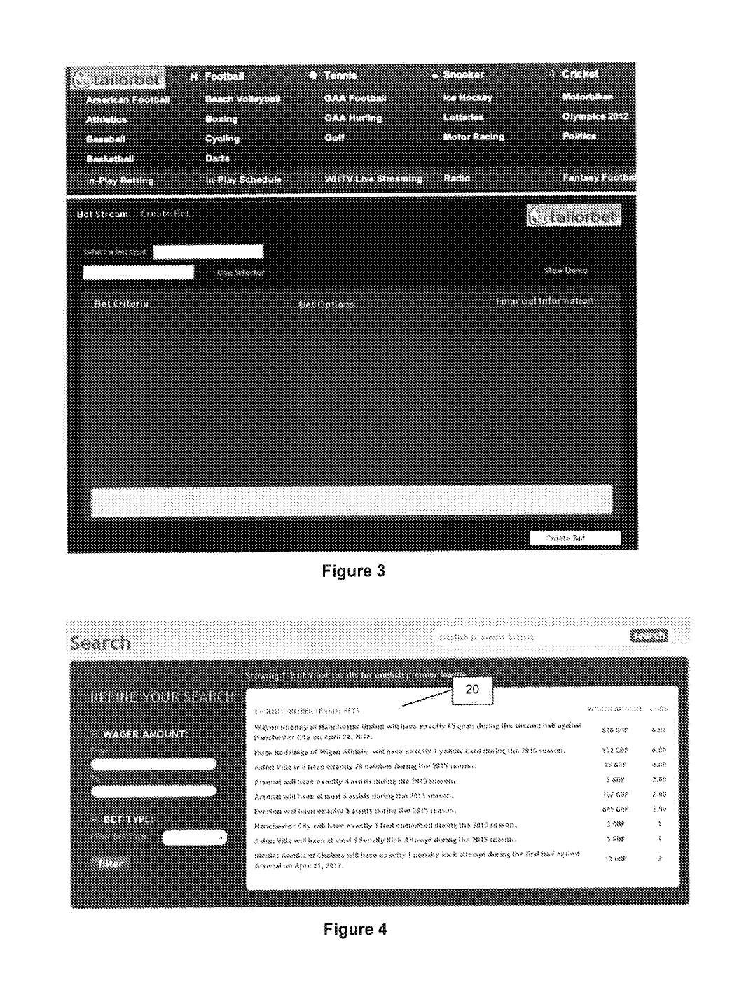

FIG. 3 shows an example of a sportsbook service which includes parsed partial transactions provided by the system 1. If the parsed partial transactions are streamed to the user node or nodes 4, the sportsbook may display a stream of parsed partial transactions available, or may alternatively provide a snapshot of the parsed partial transactions available at a particular time. Alternatively, other methods of providing information regarding the parsed partial transactions may be used, dependent upon the application of the system 1 sought.

The user node or nodes 4 may be in locations which are remote from one another, and may all be different sportsbooks. Each sportsbook may provide the same parsed partial transactions, or alternatively, each sportsbook may provide different parsed partial transactions. It is also possible that some sportsbooks may provide some of the same parsed partial transactions, and may provide other, different, parsed partial transactions.

The sportsbooks may be accessible to users, and access may be provided to users by way of an internet connection or a private network connection, or any other suitable connection means dependent upon the intended use of the system 1. Users may connect to the user node or nodes 4 and therefore the sportsbooks by way of clients 6, and the user node 4 or sportsbook to which a client may connect may be determined by the user's geographical location, or any other suitable determination means. In the case of private bets, the clients 6 may not connect to sportsbooks, but may connect to a user node or nodes 4 which deals entirely with private bets. Alternatively, the clients 6 may connect directly to the central node 2, usually via the parsing module 5.

The client 6 may be a web client, and may be in two-way data communication with the client node or nodes 4, and may provide a user present a user with a form or the like. Data inputted into the form may be transmitted to the user node 4, for storage or processing, and a copy of the inputted data may be stored locally on the client 6.

The inputted data may then be used to complete a partial transaction which has been delivered, via the parsing module 5 or otherwise, to the user node or node 4 and subsequently to the client 6.

The data regarding the completed transaction may then be transmitted to the central node 3. A complete transaction may be a completed sale, bet or wager, and may be a finalised transaction, with the transaction completed by a complementary payment or offer of payment.

Multiple completed transactions may be transmitted from the client 6 to the user node or nodes 4, on the basis that one partial transaction may give rise to more than one completed transaction, because more than one payment or offer of payment could be made against one partial transaction.

It is to be understood that one client 6 may connect to multiple user nodes 4 and therefore multiple sportsbooks—one client 6 may not necessarily be limited to one particular sportsbook and user node 4.

A completed transaction (a partial transaction which has been matched with an offer and completed) may also undergo a verification step, to confirm the authenticity and validity of the completed transaction. Once the partial transaction has been completed at a client 6 or user node 4, a statistics file, which may contain relevant details regarding the completed transaction, may be generated.

The statistics file may then be transmitted, via the parsing module 5, to the central node 2. When the statistics file is parsed by the parsing module 5 and subsequently transmitted to the central node 2, the statistics file, in combination with the completed transaction, may be filtered, and stored in a database on or connected to the central node 2.

The validation step may then cause the central node 2 to correlate a matched transaction or matched transactions with the information stored in and parsed from the stats files. Once a completed transaction has been verified, the central node may transmit a notification to the user node 4 of the results of the validation step.

An example of the options presented to a user at a user node 4 is shown in FIG. 4. As can be seen in FIG. 4, a user may select a partial transaction or transactions 20, and may search through available partial transactions. When the desired partial transaction or transactions 20 is/are found, the user may make an offer to complete the partial transaction, converting it into a completed transaction.

In use, a user would log on to the delivery node 3, and set out the terms of a bet or wager to be converted into a partial transaction. The user would then submit the bet or wager, via the delivery node 3, to the central node 2. The partial transaction would then be generated and checked at the central node 2, and stored in the database of available partial transactions.

The partial transaction would then be parsed by the parsing module 5 and delivered to at least one user node 4, for incorporation into a sportsbook system. The sportsbook system would then be connected to by a user or users via client or clients 6, and the partial transaction would be made available for completion and conversion into at least one completed transaction.

Once the partial transaction has been accepted and completed, the completed transaction would be transmitted to the central node 2, having undergone the validation step discussed above.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. An interactive system for creating, offering and processing a series of partial transactions between one or more nodes in substantially real time to establish a complete transaction between two nodes, the system comprising:
a delivery node for offering partial transactions;
a central node configured to receive and collate partial transactions from the delivery node and to provide information regarding partial transactions simultaneously to one or more user nodes configured to receive and review partial transactions from the central node; wherein
a parsing module is provided which is configured to amend pre-selected details pertaining to the or each partial transaction delivered to it by the delivery node to generate at least one parsed partial transaction;
the central node provides the or each parsed partial transaction to the or each user node; and
the central node is configured to receive at least one reviewed parsed partial transaction from the or each user node and to convert the or each reviewed parsed partial transaction into a complete transaction, and to subsequently provide information regarding the or each completed transaction to the delivery node.

2. A system according to claim 1, wherein the delivery node constructs the partial transactions based on criteria entered at the delivery node.

3. A system according to claim 1, wherein the parsing module parses the transactions dependent upon the intended recipient user node.

4. A system according to claim 1, wherein the parsing module is a part of the central node.

5. A system according to claim 1, wherein the parsing module is configured to parse a partial transaction and present the same parsed partial transaction in a different form to two different user nodes.

6. A system according to claim 1, wherein the parsing module is configured to parse a partial transaction and present the partial transaction to a particular user node dependent upon the content of the partial transaction.

7. A system according to claim 1, wherein the central node is configured to provide the same parsed partial transaction to two differing user nodes but present the same transaction in a different form, the transaction conveying the same technical information to each user node with the transaction being expressed at each user node differently.

8. A system according to claim 1, wherein different central nodes are operable to offer only a predetermined selection of parsed partial transactions, which are different, to the same user node, or wherein different central nodes are operable to offer only a predetermined selection of parsed partial transactions, which are not different, to the same user node.

9. A system according to claim 1, wherein a matching engine to match partial transactions is provided to assist pairing a user node with a partial transaction offered on a central node.

10. A system according to claim 1, wherein the matching engine is a part of the central node.

11. A system according to claim 1, wherein a partial transaction comprises an offered wager composed of bet terms, bet options and a wager or odds.

12. A system according to claim 1, wherein an availability engine dictates partial transaction availability to the central node with reference to the identity of a user node, with only the predetermined selected offered transactions and completed transactions for that user node being accessible by that particular user node.

13. A system according to claim 1, wherein the user node comprises a sportsbook service provider system.

14. A system according to claim 1, wherein the user node comprises a user-facing client terminal.

15. A system according to claim 1, wherein a partial transaction is constructed between the delivery node and the central node and provided to a verification engine for verification and then, if verified, is offered to the or each user node.

16. A system according to claim 1, further comprising a selection engine to determine if a partial transaction from the central node is eligible for offer to a user node depending on selection criteria including at least the nature of the transaction and the identity of the user node so that the or each user node has access to offer a predetermined selection of partial transactions from the central node.

17. A system according to claim 16, wherein the selection engine is part of the central node.

18. A system according to claim 16, wherein the selection engine determines the pre-selected details to be amended by the parsing module.
